(19) United States
(12) Patent Application Publication
(10) Pub. No.: US 2013/0058276 A1
(43) Pub. Date: Mar. 7, 2013

(54) METHOD AND APPARATUS FOR SIGNALING SIDE INFORMATION FOR NETWORK CODING IN A WIRELESS COMMUNICATION NETWORK

(71) Applicants: Kiran K. Somasundaram, San Diego, CA (US); Stefan Brueck, Neunkirchen am Brand (DE); Feng Xue, Foster City, CA (US); Christian Pietsch, Nuremberg (DE); Siddhartha Mallik, San Diego, CA (US)

(72) Inventors: Kiran K. Somasundaram, San Diego, CA (US); Stefan Brueck, Neunkirchen am Brand (DE); Feng Xue, Foster City, CA (US); Christian Pietsch, Nuremberg (DE); Siddhartha Mallik, San Diego, CA (US)

(73) Assignee: QUALCOMM INCORPORATED, San Diego, CA (US)

(21) Appl. No.: 13/604,431

(22) Filed: Sep. 5, 2012

Related U.S. Application Data
(60) Provisional application No. 61/532,041, filed on Sep. 7, 2011.

(51) Int. Cl. H04W 4/18

(52) U.S. Cl. 370/328

(57) ABSTRACT

Techniques for efficiently sending side information to support network coding in a wireless network are disclosed. A node may send a subset of packet identifiers (IDs) for received packets in order to reduce signaling overhead in support of network coding operations. In one design, a node obtains a plurality of received packets, with each received packet being generated based on at least one base packet in a set of base packets. The node determines a reduced set of base packet IDs for the received packets. The reduced set may be a subset of an overall set including base packet IDs of all base packets for each of the received packets. The node sends information conveying the reduced set of base packet IDs, receives a network-coded packet generated based on the sent information, and recovers a base packet intended for the node based on the network-coded packet.

The present application claims priority to provisional U.S. Application Ser. No. 61/532,041, entitled “METHOD AND APPARATUS FOR SIGNALING SIDE INFORMATION FOR NETWORK CODING IN A WIRELESS COMMUNICATION NETWORK,” filed Sep. 7, 2011, and incorporated herein by reference in its entirety.

### BACKGROUND

I. Field

The present disclosure relates generally to communication, and more specifically to techniques for supporting wireless communication.

II. Background

Wireless communication networks are widely deployed to provide various communication content such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks. A wireless communication network may also be referred to as a wide area network (WAN).

A wireless communication network may include a number of base stations that can support communication for a number of devices. A device may communicate with a base station for WAN communication. A device may also be able to communicate directly with one or more other devices for peer-to-peer (P2P) communication. It may be desirable to efficiently support communication for devices.

### SUMMARY

Techniques for efficiently sending side information to support network coding are disclosed herein. For network coding, a node may generate a network-coded packet based on multiple base packets and may transmit the network-coded packet to enable other nodes to recover their intended base packets. To support network coding, “overhearing” nodes that receive packets not intended for them may send side information to “encoding” nodes. The encoding nodes may generate network-coded packets based on the side information received from the overhearing nodes such that these overhearing nodes can recover their base packets.

In one aspect of the present disclosure, an overhearing node may send a subset of base packet identifiers (IDs) for its received packets in order to reduce the amount of side information to send to encoding nodes to support network coding. In one design, a node may obtain a plurality of received packets, with each received packet being generated based on at least one base packet in a set of base packets. The node may determine a reduced set of base packet IDs for the plurality of received packets. The reduced set may be a subset of an overall set comprising base packet IDs of all base packets for each of the plurality of received packets. The node may send information conveying the reduced set of base packet IDs to at least one node. The node may thereafter receive a network-coded packet generated by a second node based on the information sent by the node. The node may recover a base packet intended for the node based on the network-coded packet and at least one of the plurality of received packets.

In another aspect of the present disclosure, an overhearing node may incrementally send side information, e.g., as more received packets are obtained by the node. The node may update its packet buffer as each new received packet is obtained by the node. The node may send side information in increments in order to reduce signaling overhead.

In one aspect, a node may send first information identifying base packets used to generate at least one received packet at a node. The node may obtain at least one additional received packet. The node may determine second information identifying base packets used to generate the at least one additional received packet. The second information may be determined based on the first information already sent by the node, as described below. The node may send the second information to at least one node. The node may receive a network-coded packet generated by a second node based on the first and second information sent by the node. The node may recover a base packet intended for the node based on the network-coded packet.

Various additional aspects and features of the disclosure are described in further detail below.

### BRIEF DESCRIPTION OF THE DRAWINGS

FIG. 1 shows a wireless communication network.

FIG. 2 shows an example of P2P communication with network coding.

FIG. 3 shows a matrix-vector product for received packets.

FIGS. 4A and 4B show examples of processed coefficient matrices in row echelon form (REF) and reduced row echelon form (RREF), respectively.

FIG. 5 shows a process for incrementally sending side information.

FIG. 6 shows a timeline for incrementally sending side information.

FIG. 7 shows a process for sending side information to support network coding.

FIG. 8 shows a process for incrementally sending side information.

FIG. 9 shows a process for receiving side information.

FIG. 10 shows a block diagram of a design of two nodes.

FIG. 11 shows a block diagram of another design of two nodes.

### DETAILED DESCRIPTION

The techniques described herein may be used for various wireless communication networks such as CDMA, TDMA, FDMA, OFDMA, SC-FDMA and other wireless networks. The terms “network” and “system” are often used interchangeably. A CDMA network may implement a radio technology such as Universal Terrestrial Radio Access (UTRA), cdma2000, etc. UTRA includes Wideband CDMA (WCDMA), Time Division Synchronous CDMA (TD-SCDMA), and other variants of CDMA. cdma2000 includes IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi and Wi-Fi Direct), IEEE 802.16 (WiMAX), IEEE 802.20, Flash-OFDM®, etc. UTRA, E-UTRA, and GSM are part of Universal Mobile Telecommunication System (UMTS). 3GPP Long Term Evolution (LTE) and LTE-Advanced (LTE-A), in both frequency division duplexing (FDD) and time division duplexing (TDD), are recent releases of UMTS that use E-UTRA, which employs OFDMA on the downlink and SC-FDMA on the uplink. UTRA, E-UTRA, GSM, UMTS, LTE and LTE-A are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies.

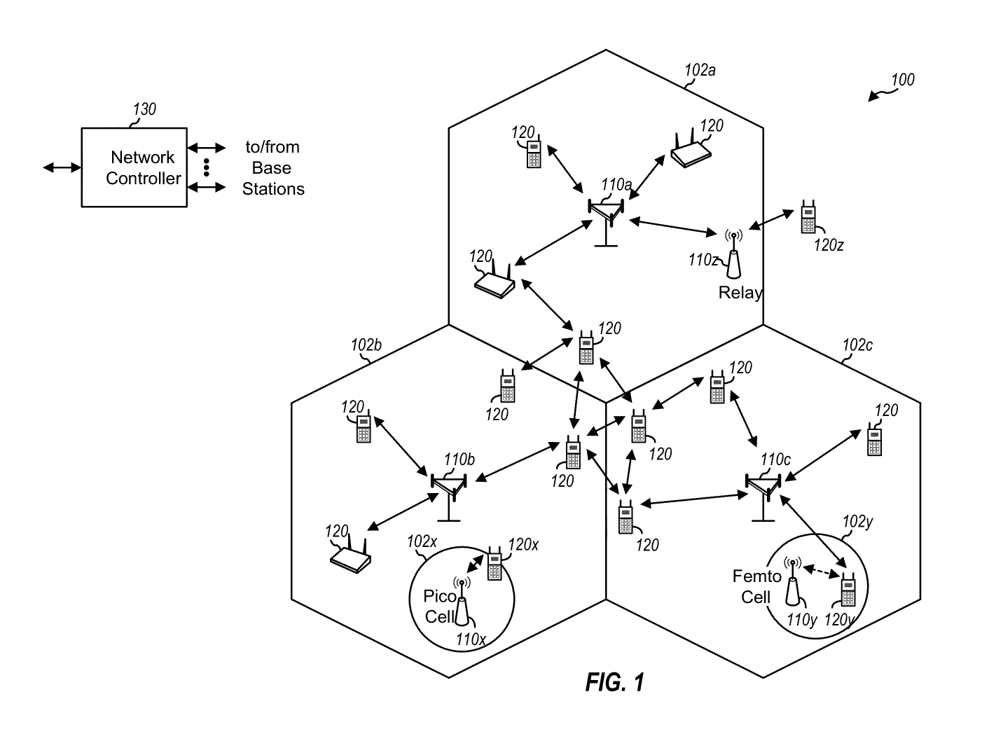

FIG. 1 shows a wireless communication network (or WAN) 100, which may be an LTE network or some other wireless network. Wireless network 100 may include a number of base stations 110 and other network entities. A base station may be an entity that communicates with devices and may also be referred to as a Node B, an evolved Node B (eNB), an access point, etc. Each base station may provide communication coverage for a particular geographic area and may support communication for the devices located within the coverage area. In 3GPP, the term “cell” can refer to a coverage area of a base station and/or a base station subsystem serving this coverage area, depending on the context in which the term is used. In 3GPP2, the term “sector” or “cell-sector” can refer to a coverage area of a base station and/or a base station subsystem serving this coverage area. For clarity, 3GPP concept of “cell” is used in the description herein.

A base station may provide communication coverage for a macro cell, a pico cell, a femto cell, and/or other types of cell. In the example shown in FIG. 1, base stations 110a, 110b and 110c may be macro base stations for macro cells 102a, 102b and 102c, respectively. A base station 110x may be a pico base station for a pico cell 102x. A base station 110y may be a home base station (HBS) for a femto cell 102y.

Wireless network 100 may also include relays. A relay may be an entity that can receive a transmission of data from an upstream station (e.g., a base station or a device) and send a transmission of the data to a downstream station (e.g., a device or a base station). A relay may also be a device that can relay transmissions for other devices. In the example shown in FIG. 1, a relay 110z may communicate with a device 120z and base station 110a in order to facilitate communication between base station 110a and device 120z.

A network controller 130 may couple to a set of base stations and may provide coordination and control for these base stations. Network controller 130 may communicate with the base stations via a backhaul. The base stations may also communicate with one another via the backhaul.

Devices 120 may be dispersed throughout wireless network 100, and each device may be stationary or mobile. A device may also be referred to as a user equipment (UE), a station, a mobile station, a terminal, an access terminal, a subscriber unit, etc. A device may be a cellular phone, a smartphone, a tablet, a wireless communication device, a personal digital assistant (PDA), a wireless modem, a handheld device, a laptop computer, a cordless phone, a wireless local loop (WLL) station, a netbook, a smartbook, etc. A device may be able to communicate with base stations, other devices, etc.

In the description herein, a node may be a device, a relay, a base station, or some other entity. A node may be within listening range of any number of other nodes. A node (e.g., a device) may communicate with other nodes of the same type (e.g., other devices) for peer-to-peer (P2P) communication and with nodes of other types (e.g., base stations) for WAN communication.

Wireless network 100 may support network coding in order to improve performance. For network coding, a node may generate a network-coded packet comprising multiple base packets and may transmit the network-coded packet to enable other nodes to recover their intended base packets. A packet may also be referred to as a message, a transport block, etc. A base packet is a packet that is not generated based on other packets. A base packet may also be referred to as a natural packet, an uncoded packet, an original packet, etc. A network-coded packet is a packet comprising multiple base packets. A network-coded packet may also be referred to as an encoded packet, etc.

Table 1 lists exemplary terminology used in the description herein. A base packet may be assigned a base packet ID (or simply, a packet ID), which may uniquely identify the base packet. A packet ID may be assigned to a packet, or may be obtained by hashing the content of the packet header, or may be determined in other manners. A packet ID may be explicitly sent in a packet (e.g., in a packet header) or may be implicitly sent in the packet (e.g., via the content of the packet).

TABLE 1
Terminology

| | Nota- | |
|---|---|---|
| Term | tion | Description |
| Base packet | pᵢ | A packet not generated based on |
| | | another packet. |
| Network-coded packet | cᵢ | A packet comprising multiple |
| | | base packets. |
| Received packet | rᵢ | A packet received by a node. |
| Overheard packet | | A packet received by a node but |
| | | intended for another node. |
| Innovative packet | | A packet that cannot be derived from |
| | | a linear combination of received packets |
| | | at a node. |
| Packet ID | id(pᵢ) | An identifier (ID) of a base packet pᵢ. |
| Packet buffer | | A buffer used to store received packets |
| | | at a node. |
| Side information | | Information available at a node |
| | | corresponding to packets received by |
| | | the node but intended for other nodes. |
| Overhearing node | | A node that receives packets intended |
| | | for other nodes. |
| Encoding node | | A node that sends network-coded packets |
| | | to other nodes based on side information |
| | | received from these other nodes. |
| Neighbor node | | A node that is within vicinity of |
| | | another node. |

Network coding may derive its gain from the local broadcast nature of a wireless channel. In particular, neighboring nodes (e.g., base stations, relays, devices, etc.) may overhear transmissions that are not intended for these nodes. The ability to overhear transmissions for other nodes may be used in network coding schemes to increase spectral efficiency of over-the-air (OTA) transmissions.

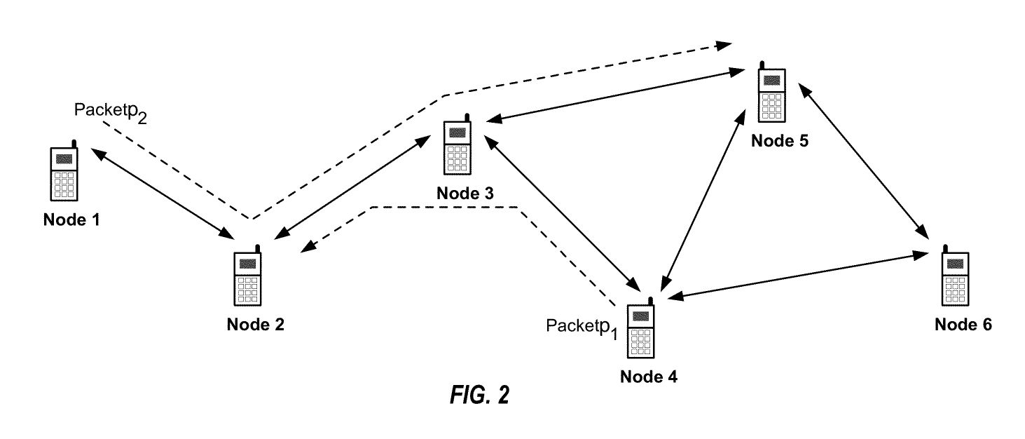

FIG. 2 shows an example of P2P communication with network coding. In this example, six nodes 1 through 6 (e.g., devices) may communicate in a multi-hop fashion. A solid line with double arrows between two nodes indicates that the two nodes can communicate directly with each other. For example, node 2 can communicate with node 3 but not node 4.

Some nodes may desire to send packets to other nodes that are not in direct communication with the sending nodes. For example, node 4 may desire to send a packet p₁ to node 2, and node 1 may desire to send a packet p₂ to node 5. However, there is no direct link between node 4 and node 2 and also no direct link between node 1 and node 5. Hence, intermediate nodes 2 and 3 can relay packets p₁ and p₂ in order to deliver these packets to their intended recipient nodes. For example, packet p₁ may be forwarded along path 4→3→2, and packet p₂ may be forwarded along path 1→2→3→5.

When node 4 transmits packet p₁ to node 3, this transmission may be overheard by node 5 due to the local broadcast nature of the wireless channel. Consequently, node 5 may know packet p₁ and may have side information for packet p₁. Side information refers to knowledge of packets not intended for a node. The reception by a node of transmissions not intended for the node may be referred to as opportunistic overhearing. Opportunistic overhearing may result in a gain of side information, which may increase local broadcast capacity.

Network coding may be used to increase local broadcast capacity. This gain may be illustrated for the example shown in FIG. 2. Since packet p₁ is forwarded along path 4→3→2 and packet p₂ is forwarded along path 1→2→3→5, intermediate node 3 should forward packet p₁ to node 2 and forward packet p₂ to node 5. In this example, node 2 may know packet p₂ because node 2 forwarded this packet from node 1 to node 3. Similarly, node 5 may know packet p₁ because of opportunistic overhearing.

A node may know a packet that is intended to be delivered for another node, which may be side information for the local broadcast channel. For example, node 5 may be the intended recipient of packet p₂ and may know packet p₁ intended for node 2. Similarly, node 2 may be the intended recipient of packet p₁ and may know packet p₂ intended for node 5.

If the side information (e.g., information regarding the availability of packet p₂ at node 2 and the availability of packet p₁ at node 5, but not the packet themselves) is signaled to node 3, then node 3 can efficiently deliver both packets to the intended recipient nodes. For example, node 3 may compute a network-coded packet c₁ as c₁=p₁⊕p₂, where “⊕” may denote a bitwise exclusive-OR (XOR) operation, e.g., on bits of the packet. Node 3 may transmit packet c₁ over the air. Node 5 already has packet p₁ (side information) and can recover its intended packet p₂ based on packets p₁ and c₁. Similarly, node 2 already has packet p₂ (side information) and can recover its intended packet p₁ based on packets p₂ and c₁. Since node 3 transmits a single network-coded packet c₁ comprising both packets p₁ and p₂ (instead of transmitting packets p₁ and p₂ individually), network coding can provide a gain in spectral efficiency.

To achieve spectral efficiency gain with network coding, overhearing nodes may signal their side information to encoding nodes. In the example shown in FIG. 2, node 5 may signal to node 3 that it has overheard packet p₁, and node 2 may signal to node 3 that it has overheard packet p₂. Encoding node 3 may use the side information from nodes 2 and 5 to determine how to generate a network-coded packet that can be used by both nodes 2 and 5 to recover their intended packets.

In general, an encoding node may receive side information of what neighbor nodes have overheard and reported. The encoding node may use the side information to select a set of base packets intended for the neighbor nodes. The encoding node may combine the set of the base packets (e.g., by XORing the bits of the packets) to generate a network-coded packet. The set of base packets and the neighbor nodes may be selected such that each neighbor node has the necessary side information to recover a base packet is intended for that neighbor node based on the network-coded packet.

In general, network coding may be used for one hop, multiple hops, or end-to-end. In one design, network coding may be used for one-hop neighbor nodes and may be referred to as local network coding. In this design, network coding is not intended not permeate more than one hop. For local network coding, an encoding node may generate a network-coded packet based on a set of base packets intended for all or a subset of its one-hop neighbor nodes. In another design, network coding may permeate more than one hop. In yet another design, network coding may be used end-to-end. In this design, network coding may permeate from a source node to a destination node in a given session. The techniques described herein may be used for one-hop network coding, multi-hop network coding, and end-to-end network coding.

For network coding, each node in a wireless network may receive/overhear transmissions of neighbor nodes (e.g., one-hop neighbor nodes) and may store received/overheard packets in a packet buffer at that node. The packet buffer may be a container for side information of the node. The received packets may include base packets and/or network-coded packets.

In general, a packet may include any number of symbols. Each symbol of a packet may be an element of a Galois field of size Q, or GF(Q), where Q may be 2 or some other value. For example, each symbol may have a binary value of either 0 or 1 for GF(2) or may have a value within a range of 0 to Q−1 for GF(Q), where Q>2.

In general, multiple packets may be combined or mixed based on any linear function to generate a network-coded packet. In one design, multiple packets may be combined based on an XOR function modulo Q to generate a network-coded packet. Furthermore, multiple packets may be combined either before channel coding or after channel coding. For network coding before channel coding, multiple packets may be combined (e.g., by XORing payload/data bits of the multiple packets) to obtain combined bits, which may then be encoded (e.g., with a convolutional code, a Turbo code, a block code, etc.) to obtain code bits of a network-coded packet. For network coding after channel coding, multiple packets may each be encoded to obtain code bits, and the code bits of the multiple packets may then be combined (e.g., by XORing codes bits of the multiple packets) to obtain code bits of a network-coded packet.

Network coding may be illustrated by an example that refers back to the scenario shown in FIG. 2. In this example, node 3 may have three base packets p₁, p₂ and p₃ intended for nodes 2, 4 and 5, respectively. Node 3 may generate a network-coded packet c₁ based on the three base packets as c₁=p₁⊕p₂⊕p₃. Node 3 may generate this network-coded packet if it knows that the intended recipient nodes 2, 4 and 5 have sufficient side information to recover their base packets from the network-coded packet. In particular, node 2 should have side information about p₂⊕p₃ in order to recover its base packet p₁ based on the network-coded packet. Node 4 should have side information about p₁⊕p₃ in order to recover its base packet p₂ based on the network-coded packet. Node 5 should have side information about p₁⊕p₂ in order to recover its base packet p₃ based on the network-coded packet. Node 3 may perform a decodability check based on the side information available at each intended recipient node. A decodability check is a determination of whether a network-coded packet can be generated for at least one node such that each node can use the network-coded packet to recover a base packet intended for that node. For one-hop network coding, network encoding and decoding may occur within one-hop communication. In the example shown in FIG. 2, nodes 1 and 6, which are two-hop neighbors of node 3, would not be involved in the network coding operation described above.

To facilitate network coding, an encoding node (e.g., node 3 in FIG. 2) should have knowledge of side information of overhearing nodes (e.g., nodes 2, 4 and 5 in FIG. 2), which are neighbor nodes of the encoding node. This may be achieved by having the overhearing nodes send their side information to the encoding node, e.g., via a control channel or a data channel, either periodically or on-demand.

In one conventional scheme for sending side information, an overhearing node may send a list of packet IDs for each received packet in a packet buffer at the overhearing node. A network-coded packet may be represented by a list of packet IDs of all constituent base packets that make up the network-coded packet. For example, a network-coded packet cᵢ=p₁⊕p₂⊕ . . . ⊕pₖ may be denoted by a list of packet IDs {{id(p₁), id(p₂), . . . , id(pₖ)} for constituent base packets p₁, p₂, . . . , pₖ of network-coded packet cᵢ. The list of packet IDs may be included in a header of the network-coded packet and may be obtained by the overhearing node from the header. The overhearing node may signal/send the content of its packet buffer to an encoding node by sending a list of packet IDs for each received packet in the packet buffer at the overhearing node. For example, the packet buffer at the overhearing node may include three received packets for (i) two network-coded packets c₁=p₁⊕p₂ and c₂=p₂⊕p₃⊕p₄ and (ii) one base packet c₃=p₂. The first received packet may be generated with base packets 1 and 2, the second received packet may be generated with base packets 2, 3 and 4, and the third received packet may be generated with base packet 2. The overhearing node may then send side information comprising (i) the packet IDs of base packets 1 and 2, id(p1) and id(p2), for the first received packet, (ii) the packet IDs of base packets 2, 3 and 4, id(p2), id(p3), and id(p4), for the second received packet, and (iii) the packet ID of base packet 2, id(p2), for the third received packet. The overhearing node may thus signal three lists of packet IDs of {id(p₁), id(p₂)}, {id(p₂), id(p₃), id(p₄)}, and {id(p₂)} to the encoding node.

In the conventional scheme described above, the overhearing node may send side information identifying all base packets of all network-coded packets in its packet buffer to an encoding node. In particular, the overhearing node may send packet IDs of all constituent base packets of all network-coded packets received by the overhearing node. If the number of overhearing nodes is large and/or if the number of network-coded packets at each overhearing node is large, then signaling overhead may be prohibitively large in order to realize gains from network coding.

In an aspect of the present disclosure, an overhearing node may send a subset of packet IDs for received packets in its packet buffer in order to reduce the amount of side information to send to an encoding node. The received packets at the overhearing node may include base packets and/or network-coded packets. The subset of packet IDs may be selected such that:
1. The representation of the content of the packet buffer is compact in order to reduce signaling overhead, and
2. The representation of the content of the packet buffer can enable the encoding node to perform decodability check for the overhearing node.

Side information may be reduced by recognizing that there is typically correlation in the constituent base packets of the received packets in the packet buffer of the overhearing node. Signaling overhead may be reduced by exploiting this correlation, as described below. The overhearing node may signal side information for received packets such that redundant information can be eliminated or reduced. This facilitates efficient use of OTA resources.

Reduction of side information may be illustrated by the example described above in which the packet buffer of the overhearing node may include three received packets r₁=p₁⊕p₂, r₂=p₂⊕p₃⊕p₄, and r₃=p₂. Conventionally, the overhearing node would send three sets of packet IDs of {id(p₁), id(p₂)}, {id(p₂), id(p₃), id(p₄)}, and {id(p₂)} for the three received packets to the encoding node. This original representation includes a total of six packet IDs for the three received packets. However, there is correlation in the base packets which constitute the three received packets. In particular, the packet ID of base packet 2, id(2), may be sent three times in the example above, which would result in redundant information being sent as side information. A more compact representation of the three received packets may be given as {id(p₁)}, {id(p₂)} and {id(p₃), id(p₄)}. This more compact representation may be used by the overhearing node to reproduce the original representation of the three received packets. The more compact representation may also be used by the encoding node to perform decodability check for the overhearing node and to generate network-coded packets that might be useful to the overhearing node. The overhearing node may send the more compact representation {id(p₁)}, {id(p₂)} and {id(p₃), id(p₄)} to the encoding node. The more compact representation includes only four packet IDs for the three received packets and requires 33% less signaling overhead than the original representation.

From an information theoretic point of view, the overhearing node may send packet IDs of packets that are innovative and may omit packet IDs of packets that are not innovative. Innovative packets may be determined as described below.

For a set of base packets p₁ through p_{N}, where N may be any integer value, a receive packet rᵢ may be expressed as:

rᵢ=g_{i,1}·p₁⊕g_{i,2}·p₂⊕ . . . ⊕g_{i,N}·p_{N}, or Eq (1)

rᵢ=gᵢp, Eq (2)

where
gᵢ=[g_{i,1} g_{i,2} . . . g_{i,N}] is a 1×N row vector of coefficients,
p=[p₁ p₂ . . . p_{N}]^{T} is an N×1 vector of base packets, and
“^{T}” denotes a transpose.

For clarity, in the description herein, a vector is denoted by a bolded lower-case letter (e.g., gᵢ or p), a matrix is denoted by a bolded upper-case letter (e.g., G), and a scalar is denoted by a regular lower-case letter (e.g., rᵢ). A matrix may include one or more rows and one or more columns. A matrix may correspond to a vector when there is only one row or only one column.

The coefficients in vector gᵢ may be elements of GF(Q). For GF(2), each coefficient in vector gᵢ may be either 0 or 1, and vector gᵢ may include a 1 at each location corresponding to a base packet used to generate received packet rᵢ. For GF(Q), where Q>2, each coefficient in vector gᵢ may be within a range of 0 to Q−1, and vector gᵢ may include a non-zero value at each location corresponding to a base packet used to generate received packet rᵢ.

In one design, a matrix representation may be used for a set of received packets r₁ through r_{M} in a packet buffer at the overhearing node, where M may be any integer value. The set of received packets in the packet buffer may be expressed in matrix form as follows:

r=G p, Eq (3)

where
G is an M×N matrix of coefficients, and
r=[r₁ r₂ . . . rₘ]^{T} is an M×1 vector of received packets in the packet buffer.

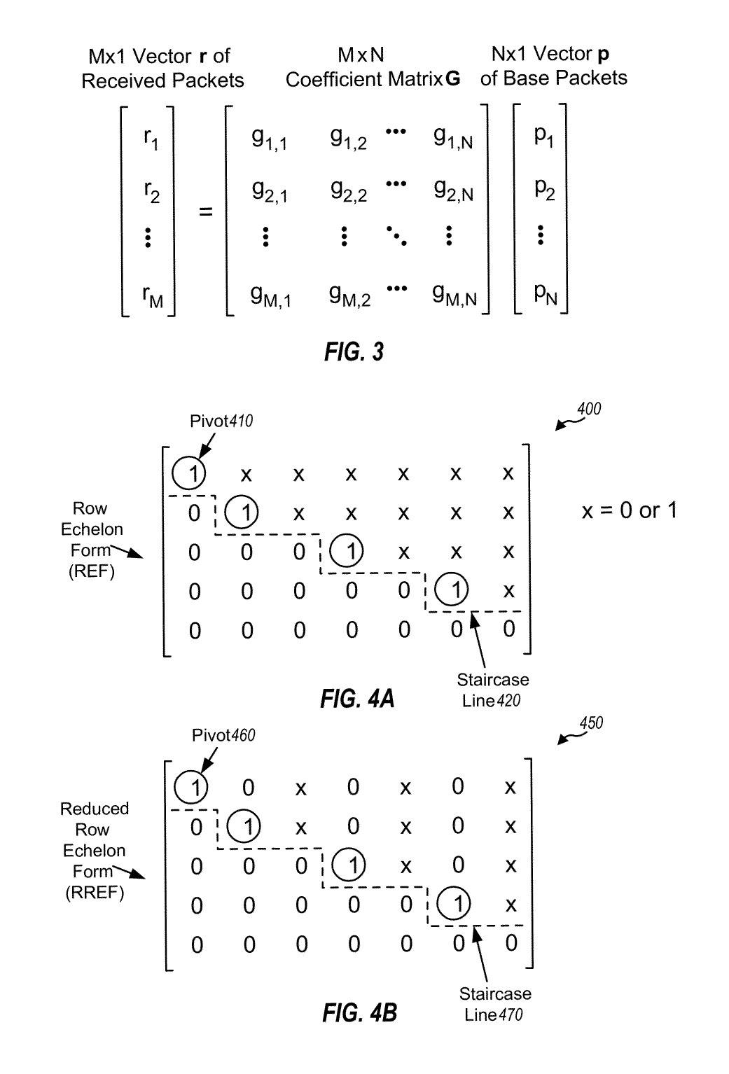

FIG. 3 graphically shows the matrix-vector product in equation (3). Vector r may include a set of M received packets {r₁, r₂, . . . , r_{M}}, and vector p may include a set of N base packets {p₁, p₂, . . . , p_{N}}, where M and N may each be any integer value. Matrix G may include M rows for the M received packets and N columns for the N base packets. Row i, for i=1, . . . , M, of matrix G may correspond to a vector gᵢ of N coefficients for received packet rᵢ. The vector of received packets may be considered as side information at the overhearing node.

As shown in equation (3) and FIG. 3, a packet buffer of received packets may be expressed as a matrix-vector product. For example, three received packets r₁, r₂ and r₃ in a packet buffer may be generated based on four base packets p₁, p₂, p₃ and p₄ as r₁=p₁⊕p₂, r₂=p₂⊕p₃⊕p₄, and r₃=p₂. The three received packets may be represented in a matrix form as follows:

$$[ \begin{matrix}{r}_{1} \\ {r}_{2} \\ {r}_{3}\end{matrix} ] = [ \begin{matrix}1 & 1 & 0 & 0 \\ 0 & 1 & 1 & 1 \\ 0 & 0 & 0 & 0 \\ 0 & 1 & 0 & 0\end{matrix} ] \cdot [ \begin{matrix}{p}_{1} \\ {p}_{2} \\ {p}_{3} \\ {p}_{4}\end{matrix} ] . \qquad Eq ( 4 )$$

Equation (4) shows an example in which the matrix-vector product is over GF(2).

The matrix representation may be defined to accommodate a changing (e.g., growing) number of received packets at the overhearing node. Vector p may include N base packets used to generate M received packets at the overhearing node at a particular time. These N base packets may be referred to as “seen” or “observed” base packets. Vectors r and p and coefficient matrix G may be updated whenever a new received packet is obtained by the overhearing node. In particular, the new received packet may be added as a new last element/entry of vector r. A new last row may be added to coefficient matrix G and may include a coefficient vector for the new received packet. If the new received packet is generated based on a new/unseen base packet that is not already included in vector p, then a new column may be added to coefficient matrix G. This new column would include a non-zero value (e.g., a value of 1 for GF(2)) for the last element corresponding to the new received packet and zeros for all remaining elements. The new base packet would also be added as a new last element of vector p.

The number of rows and the number of columns of coefficient matrix G may be limited to M and N, respectively, which may be any suitable values. The size/dimension of coefficient matrix G may be selected based on the number of neighbor nodes of the overhearing node and/or other criteria. For example, a network-coded packet may comprise at most N base packets. If there are V neighbor nodes and if up to P received packets can be stored for each neighbor node, then the coefficient matrix may have a dimension of (K*V)×N and may include M=K*V rows for received packets and N columns for base packets.

The size of coefficient matrix G may be constrained to a dimension of M×N to simplify computation and storage. Once coefficient matrix G is fully populated, a new received packet may replace an existing row of matrix G and, if necessary, an existing column of matrix G. This may be illustrated by the following example in which three received packets r₁=p₁⊕p₂, r₂=p₂⊕p₃⊕p₄ and r₃=p₂ are initially represented in matrix form as shown in equation (4), with M=3 and N=4. A new received packet r₄=p₁⊕p₃ may be obtained. Since matrix G is already completely populated, a row may be removed from the matrix. In one design, the row corresponding to the oldest received packet may be removed. In another design, the row corresponding to the least innovative packet (e.g., a received packet comprising the most number of base packets) may be removed. A row may also be selected for removal based on other criteria. If a row corresponding to the oldest received packet is removed, then received packet r₄ may replace received packet r₁, and the received packets may be expressed as:

$$[ \begin{matrix}{r}_{4} \\ {r}_{2} \\ {r}_{3}\end{matrix} ] = [ \begin{matrix}1 & 0 & 1 & 0 \\ 0 & 1 & 1 & 1 \\ 0 & 1 & 0 & 0\end{matrix} ] \cdot [ \begin{matrix}{p}_{1} \\ {p}_{2} \\ {p}_{3} \\ {p}_{4}\end{matrix} ] . \qquad Eq ( 5 )$$

In the example above, the new received packet r₄ does not include any new/unseen base packets. In particular, received packet r₄ includes base packets p₁ and p₃, which are already included in vector p. In this case, it is not necessary to update the columns of coefficient matrix G.

In the example above, at a later time, a new received packet r₅=p₁⊕p₅ may be obtained and may include a new/unseen base packet p₅. In one design, the oldest column (e.g., corresponding to the oldest base packet) that is not needed to represent the new received packet may be replaced. For example, column 2 may correspond to the oldest base packet p₂ and may be replaced with a new column for the new base packet p₅. Since base packet p₂ is removed, each received packet comprising base packet p₂ may also be removed from vectors r and p and matrix G. In the example shown in equation (5), both received packets r₂ and r₃ may be removed, and an empty row may be introduced. The received packets in the packet buffer may then be expressed as:

$$[ \begin{matrix}{r}_{4} \\ {r}_{5} \\ 0\end{matrix} ] = [ \begin{matrix}1 & 0 & 1 & 0 \\ 1 & 1 & 0 & 0 \\ 0 & 0 & 0 & 0\end{matrix} ] \cdot [ \begin{matrix}{p}_{1} \\ {p}_{5} \\ {p}_{3} \\ {p}_{4}\end{matrix} ] . \qquad Eq ( 6 )$$

In general, any number of received packets in a packet buffer may be represented in matrix form. Vectors r and p and coefficient matrix G may be updated in various manners as new received packets are obtained. The new received packets may be reflected in coefficient matrix G, which may be limited to dimension M×N.

For GF(2), coefficient matrix G may include ones at locations corresponding to base packets used to generate received packets and may include zeros at all other locations. For GF(Q), where Q>2, coefficient matrix G may include non-zero values at locations corresponding to base packets used to generate received packets and may include zeros at all other locations. In any case, the overhearing node may send a packet ID for each element having a non-zero value in matrix G. Hence, it may be desirable to reduce the number of non-zero elements (e.g., the number of ones for GF(2)) in matrix G in order to reduce signaling overhead.

Various techniques may be used to reduce the number of non-zero elements in coefficient matrix G. In a first design of reducing redundancy in coefficient matrix G, Gaussian elimination may be performed to generate a processed coefficient matrix G′ having a row echelon form (REF), which may be expressed as:

$${G}^{′} = [ \begin{matrix}{g}_{1 , 1}^{′} & {g}_{1 , 2}^{′} & … & {g}_{1 , N}^{′} \\ 0 & {g}_{2 , 2}^{′} & … & {g}_{2 , N}^{′} \\ ⋮ & ⋮ & ⋱ & ⋮ \\ 0 & 0 & … & {g}_{M , N}^{′}\end{matrix} ] . \qquad Eq ( 7 )$$

Gaussian elimination is described in various references known in the art such as (i) Carl D. Meyer, “Matrix Analysis and Applied Linear Algebra Book,” Solutions Manual and (ii) Nakos, G. and Joyner, D., “Linear Algebra with Applications,” Pacific Grove, Calif.: Brooks/Cole, pp. 15-17, 1998.

The row echelon form may have the following characteristics:
1. Rows with all zeros (if any) are located at the bottom of the matrix, and
2. If the first non-zero element in the i-th row of the matrix is at the j-th position, then all elements below the i-th position in columns 1 through j of the matrix are zeros.

Each row of the matrix may be associated with a “pivot”, which may be defined as the location of the first non-zero element in the row. A staircase line may be formed just below the pivots of all rows. For the row echelon form, only zeros may be present below the staircase line, and non-zeros may be constrained to be above the staircase line.

FIG. 4A shows an example of a processed coefficient matrix G′ 400 in row echelon form. In this example, matrix G′ includes five rows and seven columns for five received packets and seven base packets. The first non-zero element of each row is identified by a circle 410 around the element. For simplicity, only one circle 410 is labeled in FIG. 4A. The pivots corresponding to ones with circles in FIG. 4A. A staircase line 420 is formed below the pivots. All elements below staircase line 420 are zeros. Each element above staircase line 420 that does not correspond to a pivot is marked as “x” and may have a value of either 0 or 1 for GF(2).

In a second design of reducing redundancy in coefficient matrix G, Gauss-Jordan elimination techniques may be applied to coefficient matrix G to generate a processed coefficient matrix G″ having a reduced row echelon form (RREF), which may be expressed as:

$${G}^{″} = [ \begin{matrix}{g}_{1 , 1}^{″} & 0 & … & 0 \\ 0 & {g}_{2 , 2}^{″} & … & 0 \\ ⋮ & ⋮ & ⋱ & ⋮ \\ 0 & 0 & … & {g}_{M , N}^{″}\end{matrix} ] . \qquad Eq ( 8 )$$

The Gauss-Jordan elimination techniques are known in the art and described in various references including the aforementioned Meyer reference.

The RREF may have the following characteristics:
1. The matrix is in row echelon form,
2. The first non-zero element (or pivot) of each row is 1 for GF(2), and
3. All elements above each pivot are zeros.

The RREF may have all of the characteristics of the REF described above. Furthermore, the elements above each pivot are zeros. Each element above the staircase line but not above a pivot may be either 1 or 0 for GF(2).

FIG. 4B shows an example of a processed coefficient matrix G″ 450 in RREF. In this example, matrix G″ includes five rows and seven columns for five received packets and seven base packets. The first non-zero element of each row is identified by a circle 460 around the element. For simplicity, only one circle 460 is labeled in FIG. 4B. The pivots may correspond to ones with circles in FIG. 4B. A staircase line 470 is formed below the pivots. All elements below staircase line 470 are zeros. All elements above each pivot are zeros. Each remaining element above staircase line 470 is marked as “x” and may have a value of either 0 or 1 for GF(2).

For clarity, an example of reducing the number of non-zero elements in a coefficient matrix Gₐ based on Gaussian elimination is described below. In this example, coefficient matrix Gₐ is formed for three received packets generated based on four base packets and may be given as follows:

$${G}_{a} = [ \begin{matrix}1 & 1 & 0 & 0 \\ 1 & 1 & 1 & 0 \\ 1 & 1 & 0 & 1\end{matrix} ] . \qquad Eq ( 9 )$$

In the first step, the second row of coefficient matrix Gₐ may be updated based on the first and second rows of matrix Gₐ, or g_{2,new}=[(g₁+g₂) mod 2]. An updated coefficient matrix G_{b} may be given as follows:

$${G}_{b} = [ \begin{matrix}1 & 1 & 0 & 0 \\ 0 & 0 & 1 & 0 \\ 1 & 1 & 0 & 1\end{matrix} ] . \qquad Eq ( 10 )$$

In the second step, the third row of coefficient matrix G_{b} may be updated based on the first and third rows of matrix G_{b}, or g_{3,new}=[(g₁+g₃) mod 2]. An updated coefficient matrix G_{c} may be given as follows:

$${G}_{c} = [ \begin{matrix}1 & 1 & 0 & 0 \\ 0 & 0 & 1 & 0 \\ 0 & 0 & 0 & 1\end{matrix} ] . \qquad Eq ( 11 )$$

In the example above, the overhearing node may send a more compact representation of {id(p₁),id(p₂)}, {id(p₃)}, and {id(p₄)} based on the processed coefficient matrix G_{c}. The more compact representation may include four packet IDs for the three received packets. In contrast, the overhearing node may send an original representation of {id(p₁), id(p₂)}, {id(p₁), id(p₂), id(p₃)}, and {id(p₁), id(p₂), id(p₄)} based on the original coefficient matrix Gₐ. The original representation may include eight packet IDs for the three received packets. The number of packet IDs to send may be reduced substantially by processing coefficient matrix Gₐ.

In general, for Gaussian elimination, one row at a time may be processed, e.g., starting with the second row. For the row being processed, that row and one or more earlier rows in the coefficient matrix may be combined to generate a new row to replace the row being processed. The process may be repeated until all rows of the coefficient matrix have been processed. The rows of the coefficient matrix may also be shuffled or swapped to obtain REF or RREF form. The processing may result in removal of redundant packet IDs, which may reduce the amount of side information to send.

In another aspect of the present disclosure, an overhearing node may incrementally send side information, e.g., as more received packets are obtained by the overhearing node. The overhearing node may maintain a packet buffer and may update the packet buffer as each new received packet is obtained by the overhearing node. The overhearing node may send side information in increments to potential encoding nodes in a manner to reduce signaling overhead.

In one design, a coefficient matrix G_{rc} may be split into a “signaled” part and an “unsignaled” part. The signaled part may correspond to a portion of side information at the overhearing node that have already been signaled to encoding nodes and may be represented by a K×N signaled matrix G_{signaled}. The unsignaled part may correspond to a remaining portion of the side information at the overhearing node that has not been signaled to the encoding nodes and may be represented by an L×N unsignaled matrix G unsignaled. In general, 0≦K<M, 0<L≦M, and K+L=M.

Signaled matrix G_{signaled} may be an empty matrix at initialization. Coefficient matrix G_{rc} may be expressed as:

$${G}_{rc} = [ \begin{matrix}{G}_{signaled} \\ {G}_{unsignaled}\end{matrix} ] . \qquad Eq ( 12 )$$

The side information for the first K received packet may be sent previously, and the side information for the remaining L received packets may not be sent yet. Since the side information for the first K received packets has already been sent, the elements of matrix G_{signaled} may be retained (i.e., not modified) in order to maintain a common state for the packet buffer at both the overhearing node and each encoding node. However, matrix G_{unsignaled} for the unsignaled part may be processed in order to reduce the number of packet IDs used to represent the L received packets for which side information has not been sent. A compact representation of matrix G_{unsignaled} may be obtained as described below.

In one design, the L rows of matrix G_{rc} corresponding to unsignaled matrix G_{unsignaled} may be processed (e.g., with Gaussian elimination) to obtain L new rows of matrix G_{rc}, which may be referred to as a processed unsignaled matrix G_{unsignaled,RREF}. The processing (or row operations) may be performed using both the K rows of matrix G_{rc} corresponding to signaled matrix G_{signaled} and the L rows of matrix G_{rc} corresponding to unsignaled matrix G_{unsignaled}. The processing may be referred to as partial RREF since only part of matrix G_{rc} may be processed while the remaining part may be maintained.

The partial RREF operation may be illustrated by an example. In this example, K=1, L=2, M=3, and N=4. Matrices G_{rc}, G_{signaled} and G_{unsignaled} may be given as follows:

$$\begin{matrix}{G}_{signaled} = [ 1 \; 1 \; 0 \; 0 ] , & Eq ( 13 ) \\ {G}_{unsignaled} = [ \begin{matrix}0 & 1 & 1 & 1 \\ 0 & 1 & 0 & 0\end{matrix} ] , & Eq ( 14 )\end{matrix}$$

The side information for the first received packet r₁ has been sent, and the elements of matrix G_{signaled} should not be modified. Partial RREF processing may be performed on the L rows of matrix G_{unsignaled} using all M rows of matrices G_{signaled} and G_{unsignaled}. The result of the processing may be a processed unsignaled matrix G_{unsignaled,RREF}, which for the example above may be given as:

$${G}_{unsignaled , RREF} = [ \begin{matrix}0 & 1 & 0 & 0 \\ 0 & 0 & 1 & 1\end{matrix} ] . \qquad Eq ( 17 )$$

The number of non-zero elements in matrix G_{unsignaled,RREF} may be reduced due to the partial RREF processing. Packet IDs of base packets corresponding to non-zero elements of matrix G_{unsignaled,RREF} may be sent to the encoding nodes as side information for the two received packets r₂ and r₃.

After sending the packet IDs corresponding to the non-zero elements of matrix G_{unsignaled,RREF}, both the overhearing node and the encoding nodes may have the same state information for the packet buffer at the overhearing node. This state information may correspond to an updated coefficient matrix G_{rc2}, which may be expressed as:

$${G}_{rc 2} = [ \begin{matrix}{G}_{signaled} \\ {G}_{unsignaled , RREF}\end{matrix} ] . \qquad Eq ( 18 )$$

In one design, the overhearing node and the encoding nodes may each process coefficient matrix G_{rc2} to reduce the number of non-zero elements and potentially reduce signaling overhead in subsequent signaling of side information. This processing may be achieved by performing an RREF operation on the entire coefficient matrix G_{rc2} at each of the encoding and overhearing nodes. The result of the RREF operation may be a post-processed coefficient matrix G_{rc3} having fewer non-zero elements than matrix G_{rc2}. Thereafter, the overhearing node may form a new coefficient matrix by (i) using matrix G_{rc3} as signaled matrix G_{signaled} and (ii) defining unsignaled matrix G_{unsignaled} based on new received packets at the overhearing node.

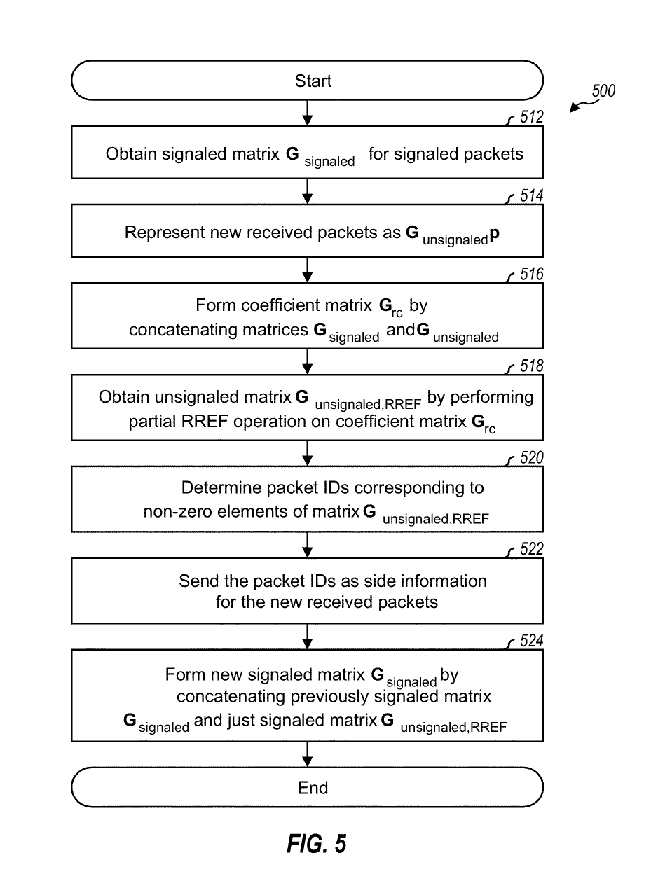

FIG. 5 shows a design of a process 500 for incrementally sending side information by an overhearing node. The overhearing node may obtain a signaled matrix G_{signaled} for signaled packets, which are received packets for which side information has already been sent by the overhearing node (block 512). Matrix G_{signaled} may be an empty matrix if no side information has been sent.

The overhearing node may represent L new received packets for which side information has not been sent with an unsignaled matrix G_{signaled} (block 514). The new received packets may be represented as r=G_{unsignaled p}. The overhearing node may form a coefficient matrix G_{rc} by concatenating signaled matrix G_{signaled} and unsignaled matrix G_{unsignaled}, e.g., as shown in equation (12) (block 516).

The overhearing node may perform partial RREF operation on the L rows of coefficient matrix G_{rc} corresponding to unsignaled matrix G_{unsignaled} to obtain a processed unsignaled matrix G_{unsignaled,RREF} (block 518). The overhearing node may determine packet IDs corresponding to non-zero elements of matrix G_{unsignaled,RREF} (block 520). The overhearing node may send the packet IDs as side information for the L new received packets (block 522). The overhearing node may then form a new signaled matrix G_{signaled} for the next signaling occasion by concatenating previously signaled matrix G_{signaled} and just signaled matrix G_{unsignaled,RREF} (block 524).

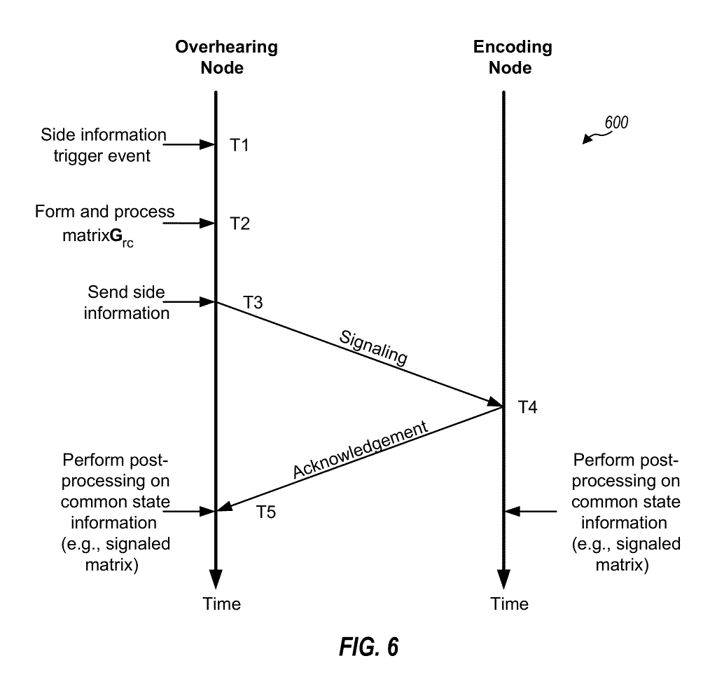

FIG. 6 shows an exemplary timeline of a design of a process 600 for incrementally sending side information. At time T1, an overhearing node may encounter a trigger event to send side information for a packet buffer at the overhearing node. This trigger event may result from expiration of a timer, or a request to send side information, or reception of one or more received packets at the overhearing node, or some other condition or event.

At time T2, the overhearing node may determine matrix G_{unsignaled}, form coefficient matrix G_{rc}, and perform processing to obtain matrix G_{unsignaled,RREF}. At time T3, the overhearing node may send packet IDs corresponding to non-zero elements of matrix G_{unsignaled,RREF}. At time T4, an encoding node may receive the packet IDs from the overhearing node and may acknowledge reception of the side information. This acknowledgement (ACK) may be skipped, e.g., if a large number of encoding nodes receive the side information from the overhearing node. After time T4, the overhearing node and the encoding node may both have common state information for the packet buffer at the overhearing node, which may be confirmed by the ACK or via a timer expiry. At time T5, the overhearing node and the encoding node may each perform post-processing on the common state information (e.g., the side information) for the overhearing node. In particular, each node may update the signaled matrix to include the previously signaled matrix G_{signaled} and the just signaled matrix G_{unsignaled,RREF} from the overhearing node. Each node may then perform post-processing on the updated signaled matrix in order to reduce the number of non-zero elements in the updated signaled matrix.

The techniques described herein may provide various advantages. First, the amount of side information to send by an overhearing node may be reduced by removing redundancy and reducing the number of non-zero elements in a coefficient matrix, e.g., based on REF or RREF. Second, decodability check by an encoding node may be simplified by receiving side information for a coefficient matrix having fewer non-zero elements from the overhearing node. Progressively more savings may be achieved for progressively larger coefficient matrix with larger M and/or N. More savings may also be achieved for more intersecting traffic flows from more overhearing nodes with more network-coded packets and/or more ones in the coefficient matrix for each overhearing node.

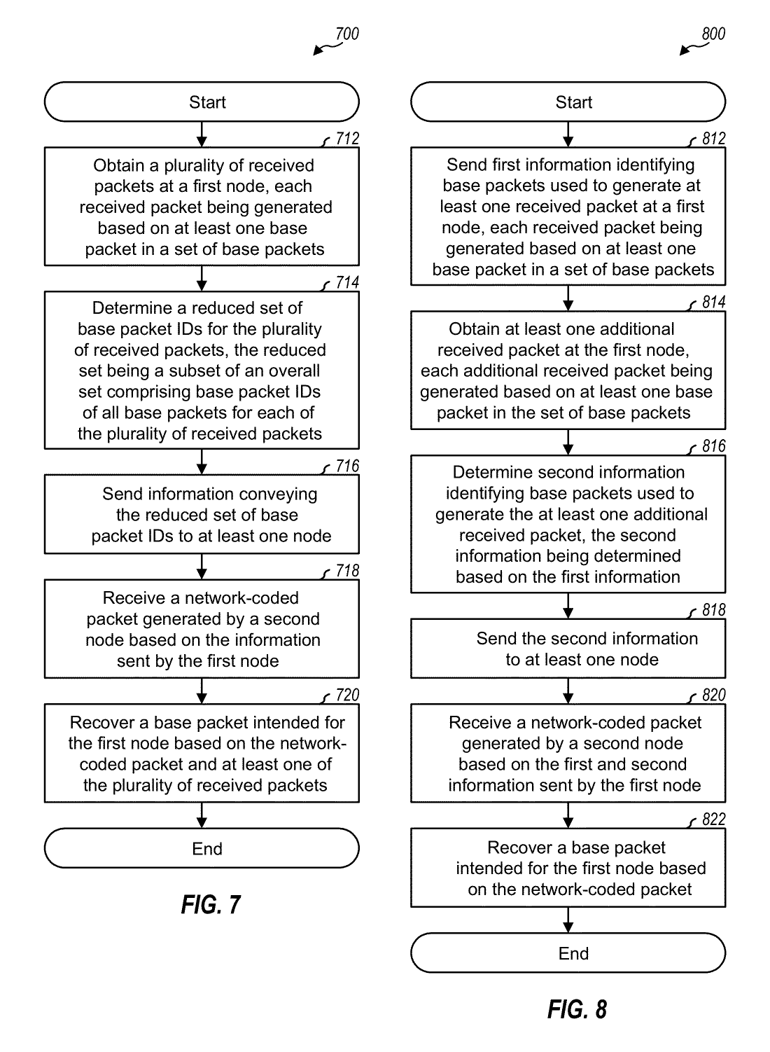

FIG. 7 shows a design of a process 700 for sending side information to support network coding in a wireless network. Process 700 may be performed by a first/overhearing node, which may be a device, a relay, a base station, or some other entity. The first node may obtain a plurality of received packets, with each received packet being generated based on at least one base packet in a set of base packets (block 712). The plurality of received packets may comprise packets not intended for the first node but decoded correctly by the first node and may correspond to side information for the first node. The plurality of received packets may include at least one network-coded packet. Each network-coded packet may be generated based on at least two base packets in the set of base packets.

The first node may determine a reduced set of base packet IDs for the plurality of received packets (block 714). The reduced set may be a subset of an overall set comprising base packet IDs of all base packets for each of the plurality of received packets. The first node may send information conveying the reduced set of base packet IDs to at least one node (block 716). The first node may thereafter receive a network-coded packet generated by a second node based on the information sent by the first node (block 718). The first node may recover a base packet intended for the first node based on the network-coded packet and at least one of the plurality of received packets at the first node (block 720).

In one design of block 714, the first node may determine at least one base packet ID of at least one base packet used to generate each of the plurality of received packets. The first node may determine the overall set to include the at least one base packet ID of the at least one base packet used to generate each received packet. The first node may process the overall set to reduce the number of base packet IDs used to represent the plurality of received packets and obtain the reduced set of base packet IDs. For example, the overall set may include id(p1), id(p2), id(p2), id(p3), id(p4) and id(p2) for three received packets in the example shown in equation (4). The reduced set may include id(p1), id(p2), id(p3) and id(p4) and may thus be a subset of the overall set. In one design, the first node may determine at least one innovative packet not derivable as a linear combination of received packets at the first node. The first node may determine the reduced set of base packet IDs based on the at least one innovative packet.

In another design of block 714, the first node may determine a coefficient matrix for the plurality of received packets, e.g., as shown in FIG. 3. The coefficient matrix may include one row for each of the plurality of received packets, with each row including at least one non-zero element corresponding to at least one base packet used to generate a corresponding received packet. The first node may process the coefficient matrix to reduce the number of non-zero elements in the coefficient matrix. For example, the first node may process the coefficient matrix based on Gaussian elimination, Gauss-Jordan elimination, or other elimination/reduction techniques. The first node may process the coefficient matrix to obtain REF or RREF form for the processed coefficient matrix. At least one row of the processed coefficient matrix may correspond to at least one innovative packet at the first node. The first node may determine the reduced set of base packet IDs based on non-zero elements of the processed coefficient matrix.

The first node may obtain a new received packet and may update the coefficient matrix based on the new received packet. For example, the first node may add a new row in the coefficient matrix for the new received packet. The first node may also replace a row of the coefficient matrix with a new row for the new received packet, e.g., if the coefficient matrix is full. In either case, the new row may include at least one non-zero element corresponding to at least one base packet used to generate the new received packet. The dimension of the coefficient matrix may be limited to a predetermined number of rows and/or a predetermined number of columns in order to reduce processing and storage requirements.

The first node may also add a new column in the coefficient matrix for the new received packet, e.g., if the new received packet is generated based on a new base packet that is not yet observed by the first node. The first node may also replace a column of the coefficient matrix with a new column for the new received packet, e.g., if the new received packet is generated based on a new base packet and the coefficient matrix is full. In either case, the new column may include a non-zero element corresponding to the new base packet used to generate the new received packet.

In one design, the coefficient matrix may comprise a signaled portion and an unsignaled portion. The first node may process the unsignaled portion of the coefficient matrix to reduce the number of base packet IDs to represent the unsignaled portion. The first node may maintain a common state of the signaled portion of the coefficient matrix at the first node and the at least one node. The first node may receive acknowledgement from the at least one node for information sent by the first node.

FIG. 8 shows a design of a process 800 for incrementally sending side information to support network coding in a wireless network. Process 800 may be performed by a first/overhearing node, which may be a device, a relay, a base station, or some other entity. The first node may send first information identifying base packets used to generate at least one received packet at the first node (block 812). Each received packet may be generated based on at least one base packet in a set of base packets. The first node may obtain at least one additional received packet (block 814). Each additional received packet may also be generated based on at least one base packet in the set of base packets. The first node may determine second information identifying base packets used to generate the at least one additional received packet (block 816). The second information may be determined based on the first information already sent by the first node. The first node may send the second information to at least one node (block 818).

The first node may receive a network-coded packet generated by a second node based on the first and second information sent by the first node (block 820). The first node may recover a base packet intended for the first node based on the network-coded packet (block 822).

In one design of block 816, the first node may form a coefficient matrix based on the at least one received packet and the at least one additional received packet. The first node may form (i) a first portion of the coefficient matrix based on the at least one received packet and (ii) a second portion of the coefficient matrix based on the at least one additional received packet. The first node may process the coefficient matrix to reduce the number of non-zero elements in the coefficient matrix. For example, the first node may process the second portion of the coefficient matrix to reduce the number of non-zero elements in the second portion while maintaining the first portion of the coefficient matrix. The first node may process the second portion of the coefficient matrix based on Gaussian elimination, Gauss-Jordan elimination, or other elimination/reduction techniques. The first node may also process the coefficient matrix to obtain REF or RREF form for the second portion of the coefficient matrix. The first node may determine a reduced set of base packets for the at least one additional received packet based on the processed coefficient matrix. The second information may comprise a base packet ID for each non-zero element in the second portion of the coefficient matrix.

In one design, the first node may perform post-processing (e.g., for Gaussian elimination, Gauss-Jordan elimination, etc.) on the processed coefficient matrix to obtain a post-processed coefficient matrix having fewer non-zero elements than the processed coefficient matrix. The post-processing may be performed independently by the first node and also by each node that receives the first and second information from the first node. The first node may receive a network-coded packet generated by a second node based on the post-processed coefficient matrix.

The first node may use the post-processed coefficient matrix to reduce the amount of side information for subsequent received packets. The first node may obtain at least one new received packet and may determine base packets used to generate the at least one new received packet. The first node may then determine a reduced set of base packets for the at least one new received packet based on the post-processed coefficient matrix and the base packets used to generate the at least one new received packet. For example, the first node may form a new coefficient matrix having (i) a first portion that includes the post-processed coefficient matrix and (ii) a second portion that includes the base packets used to generate the at least one new received packet. The first node may then process the second portion of the new coefficient matrix to reduce the number of non-zero elements in the second portion while maintaining the first portion of the new coefficient matrix. The first node may send third information comprising a base packet ID for each non-zero element in the second portion of the new coefficient matrix. The first node may maintain/synchronize the state of signaled packets between the first node and at least one other node.

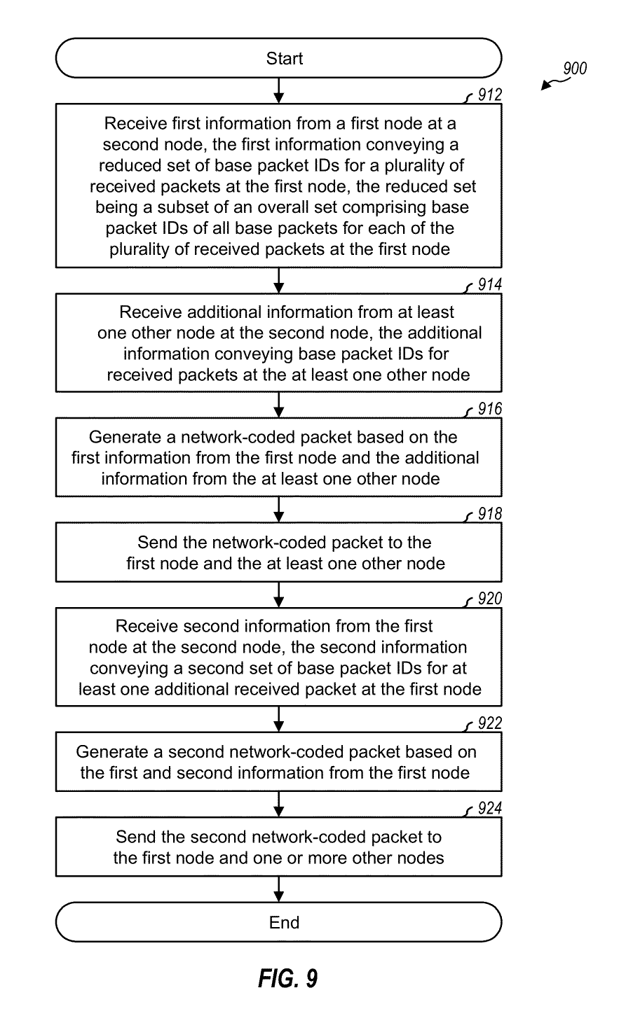

FIG. 9 shows a design of a process 900 for receiving side information sent to support network coding in a wireless network. Process 900 may be performed by a second/encoding node, which may be a device, a relay, a base station, or some other entity. The second node may receive, from a first node, first information conveying a reduced set of base packet IDs for a plurality of received packets at the first node (block 912). The reduced set may be a subset of an overall set comprising base packet IDs of all base packets for each of the plurality of received packets at the first node. The second node may receive, from at least one other node, additional information conveying base packet IDs for received packets at the at least one other node (block 914).

The second node may generate a network-coded packet based on the first information from the first node and the additional information from the at least one other node (block 916). The second node may perform a decodability check for the first node (and also for each recipient node of the network-coded packet) to determine whether the network-coded packet can be used by the first node to recover a base packet intended for the first node. The second node may send the network-coded packet to the first node and the at least one other node (block 918).

The second node may receive, from the first node, second information conveying a second set of base packet IDs for at least one additional received packet at the first node (block 920). The second information may be determined by the first node based on the first information already sent by the first node. The second node may generate a second network-coded packet based on the first and second information from the first node (block 922). The second node may send the second network-coded packet to the first node and one or more other nodes (block 924).

In one design, the second node may form (i) a first portion of a coefficient matrix for the first node based on the reduced set of base packet IDs received in block 912 and (ii) a second portion of the coefficient matrix for the first node based on the second set of base packet IDs received in block 920. The second node may perform post-processing on the coefficient matrix to obtain a post-processed coefficient matrix having fewer non-zero elements than the coefficient matrix. The second node may generate the second network-coded packet in block 922 based on the post-processed coefficient matrix.

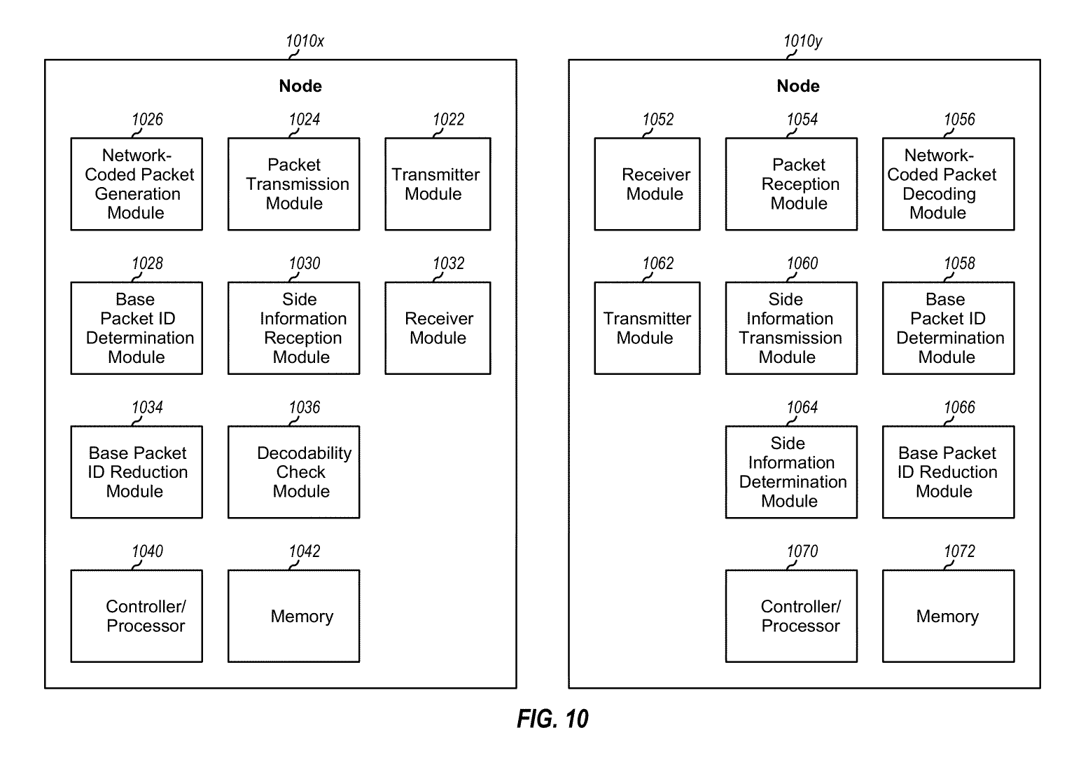

FIG. 10 shows a block diagram of a design of two nodes 1010x and 1010y supporting network coding in a wireless network. Each node 1010 may correspond to a device (e.g., a UE), a base station, a relay, etc.

Within node 1010x, a receiver module 1032 may receive signals from other nodes such as node 1010y. A module 1030 may obtain side information sent by the other nodes in their transmitted signals. A module 1028 may obtain reduced sets of base packet IDs sent by the other nodes in their side information. A module 1034 may perform post-processing to further reduce the base packet IDs sent by the other nodes. A module 1026 may identify candidate base packets for network coding based on the reduced sets of base packet IDs from the other nodes. Module 1026 may generate network-coded packets for the other nodes based on the candidate base packets. A module 1036 may perform decodability check for each node to determine whether a network-coded packet being sent to that node can be used by the node to recover its base packet. A module 1024 may process network-coded packets and base packets for transmission to other nodes. A transmitter module 1022 may transmit the network-coded packets and the base packets to other nodes. A controller/processor 1040 may direct the operation of various modules within node 1010x. A memory 1042 may store data and program codes for node 1010x.

Within node 1010y, a receiver module 1052 may receive signals from other nodes such as node 1010x. A module 1054 may process a received signal to recover packets sent by the other nodes, which may be received packets at node 1010y. A module 1056 may perform decoding for network-coded packets to recover base packets intended for node 1010y. A module 1058 may determine base packet IDs of all base packets used to generate each received packet at node 1010y. A module 1066 may reduce the base packet IDs. For example, module 1066 may form a coefficient matrix having non-zero elements corresponding to base packets used to generate each received packet. Module 1066 may process the coefficient matrix based on Gaussian elimination, Gauss-Jordan elimination, and/or other elimination/reduction techniques to reduce the number of non-zero elements in the coefficient matrix. Module 1066 may determine a reduced set of base packet IDs based on non-zero elements in the processed coefficient matrix. Module 1066 may also process one portion of the coefficient matrix while maintaining another portion of the coefficient matrix if side information is sent incrementally by node 1010y. Module 1066 may also perform post-processing on different portions of the coefficient matrix to reduce the number of non-zero elements. A module 1064 may determine side information for node 1010y based on the reduced set of base packet IDs to send by node 1010y. A module 1060 may process the side information for transmission. A transmitter module 1062 may transmit the side information to other nodes. A controller/processor 1070 may direct the operation of various modules within node 1010y. A memory 1072 may store data and program codes for node 1010y.

Nodes 1010x and 1010y may be part of different devices, different relays, or different base stations. Alternatively, nodes 1010x and 1010y may be part of the same device, the same relay, or the same base station. For example, a device may include the modules in node 1010x for packet transmission and the modules in nodes 1010y for packet reception. The modules in FIG. 10 may comprise processors, electronic devices, hardware devices, electronic components, logical circuits, memories, software codes, firmware codes, etc., or any combination thereof.

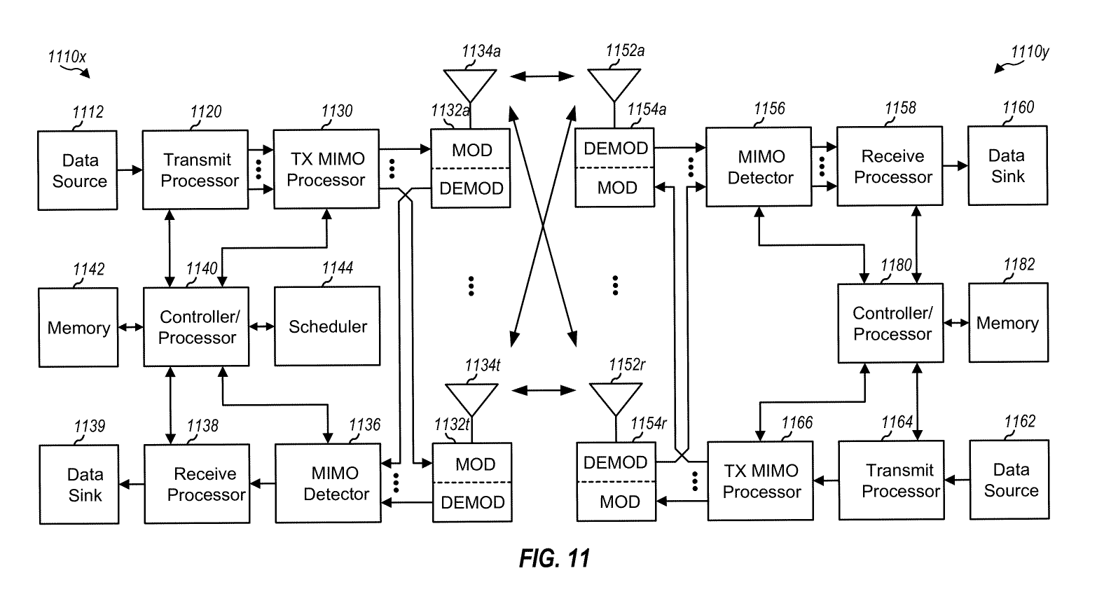

FIG. 11 shows a block diagram of a design of two nodes 1110x and 1110y. Each node 1110 may correspond to a device (e.g., a UE), a base station, a relay, etc. Node 1110x may be equipped with T antennas 1134a through 1134t, and node 1110y may be equipped with R antennas 1152a through 1152r, where in general T≧1 and R≧1.

At node 1110x, a transmit processor 1120 may receive packets of data from a data source 1112, process (e.g., encode and modulate) the packets, and provide data symbols. Transmit processor 1120 may also generate network-coded packets based on received packets and/or base packets and may provide data symbols for the network-coded packets. Transmit processor 1120 may also process control information (e.g., for base packet IDs, coefficient vectors, and/or other information for packets being transmitted) and provide control symbols. Processor 1120 may also generate reference symbols for reference signals. A transmit (TX) multiple-input multiple-output (MIMO) processor 1130 may precode the data symbols, the control symbols, and/or the reference symbols (if applicable) and may provide T output symbol streams to T modulators (MOD) 1132a through 1132t. Each modulator 1132 may process its output symbol stream (e.g., for OFDM, SC-FDM, CDMA, etc.) to obtain an output sample stream. Each modulator 1132 may further condition (e.g., convert to analog, amplify, filter, and upconvert) its output sample stream to obtain a modulated signal. T modulated signals from modulators 1132a through 1132t may be transmitted via T antennas 1134a through 1134t, respectively.

At node 1110y, antennas 1152a through 1152r may receive the modulated signals from node 1110x and/or other nodes and may provide received signals to demodulators (DEMODs) 1154a through 1154r, respectively. Each demodulator 1154 may condition (e.g., filter, amplify, downconvert, and digitize) its received signal to obtain input samples. Each demodulator 1154 may further process the input samples (e.g., for OFDM, SC-FDM, CDMA, etc.) to obtain received symbols. A MIMO detector 1156 may obtain received symbols from all R demodulators 1154a through 1154r, perform MIMO detection on the received symbols if applicable, and provide detected symbols. A receive processor 1158 may process (e.g., demodulate and decode) the detected symbols, provide decoded data for node 1110y to a data sink 1160, and provide decoded control information to a controller/processor 1180. Receive processor 1158 may perform decoding of received packets to obtain decoded received packets, which may include base packets intended for node 1110y, base packets intended for other nodes, and/or network-coded packets. Receive processor 1158 may also perform decoding of the network-coded packets to recover base packets intended for node 1110y.

At node 1110y, a transmit processor 1164 may receive and process packets of data from a data source 1162 and control information (e.g., side information) from controller/processor 1180. Processor 1164 may also generate reference symbols for one or more reference signals. The symbols from transmit processor 1164 may be precoded by a TX MIMO processor 1166 if applicable, further processed by modulators 1154a through 1154r (e.g., for OFDM, SC-FDM, CDMA, etc.), and transmitted to node 1110x. At node 1110x, the modulated signals from node 1110y and other nodes may be received by antennas 1134, processed by demodulators 1132, detected by a MIMO detector 1136 if applicable, and further processed by a receive processor 1138 to obtain decoded data and control information sent by node 1110y and other nodes. Processor 1138 may provide the decoded data to a data sink 1139 and the decoded control information to controller/processor 1140.

Controllers/processors 1140 and 1180 may direct the operation at node 1110x and node 1110y, respectively. Processor 1140 and/or other processors and modules at node 1110x may perform or direct all or part of process 500 in FIG. 5, process 600 in FIG. 6, process 700 in FIG. 7, process 800 in FIG. 8, process 900 in FIG. 9, and/or other processes for the techniques described herein. Processor 1180 and/or other processors and modules at node 1110y may perform or direct all or part of process 500, process 600, process 700, process 800, process 900, and/or other processes for the techniques described herein. Memories 1142 and 1182 may store data and program codes for node 1110x and node 1110y, respectively. A scheduler 1144 may schedule nodes for data transmission.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. A computer-readable storage medium may include any storage that can be accessed by a general purpose or special purpose computer. By way of example, and not limitation, such computer-readable storage media can comprise RAM, ROM, EEPROM, CD-ROM or other optical disk storage, magnetic disk storage or other magnetic storage devices, or any other storage medium that can be accessed by a general-purpose or special-purpose computer, or a general-purpose or special-purpose processor. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for wireless communication, comprising:
obtaining a plurality of received packets at a first node, each received packet being generated based on at least one base packet in a set of base packets;
determining a reduced set of base packet identifiers (IDs) for the plurality of received packets, the reduced set being a subset of an overall set comprising base packet IDs of all base packets for each of the plurality of received packets; and
sending information conveying the reduced set of base packet IDs to at least one node.

2. The method of claim 1, further comprising:
receiving a network-coded packet generated by a second node based on the information sent by the first node; and
recovering a base packet intended for the first node based on the network-coded packet and at least one of the plurality of received packets.

3. The method of claim 1, further comprising:
determining at least one base packet ID of at least one base packet used to generate each of the plurality of received packets; and
determining the overall set to include the at least one base packet ID of the at least one base packet used to generate each of the plurality of received packets.

4. The method of claim 3, further comprising:
processing the overall set to reduce a number of base packet IDs used to represent the plurality of received packets and obtain the reduced set of base packet IDs.

5. The method of claim 1, wherein the determining the reduced set of base packet IDs comprises
determining at least one innovative packet not derivable as a linear combination of received packets at the first node, and
determining the reduced set of base packet IDs based on the at least one innovative packet.

6. The method of claim 1, further comprising:
determining a coefficient matrix for the plurality of received packets;
processing the coefficient matrix to reduce a number of non-zero elements in the coefficient matrix; and
determining the reduced set of base packet IDs based on non-zero elements of the processed coefficient matrix.

7. The method of claim 6, wherein the processing the coefficient matrix comprises processing the coefficient matrix based on Gaussian elimination or Gauss-Jordan elimination.

8. The method of claim 6, wherein the processing the coefficient matrix comprises processing the coefficient matrix to obtain a row echelon form (REF) or a reduced row echelon form (RREF) for the processed coefficient matrix.

9. The method of claim 6, further comprising:
obtaining a new received packet at the first node; and
updating the coefficient matrix based on the new received packet.

10. The method of claim 9, wherein the updating the coefficient matrix comprises adding a new row in the coefficient matrix for the new received packet, the new row including at least one non-zero element corresponding to at least one base packet used to generate the new received packet.

11. The method of claim 9, wherein the updating the coefficient matrix comprises replacing a row of the coefficient matrix with a new row for the new received packet, the new row including at least one non-zero element corresponding to at least one base packet used to generate the new received packet.

12. The method of claim 9, wherein the updating the coefficient matrix comprises adding a new column in the coefficient matrix for a base packet used to generate the new received packet and not yet observed by the first node, the new column including a non-zero element corresponding to the base packet used to generate the new received packet.

13. The method of claim 9, wherein the updating the coefficient matrix comprises replacing a column of the coefficient matrix with a new column for a base packet used to generate the new received packet, the new column including a non-zero element corresponding to the base packet used to generate the new received packet.

14. The method of claim 6, wherein the coefficient matrix comprises a signaled portion and an unsignaled portion, and wherein the processing the coefficient matrix comprises processing the unsignaled portion of the coefficient matrix to reduce a number of base packet IDs used to represent the unsignaled portion.

15. An apparatus for wireless communication, comprising:
at least one processor configured to:
obtain a plurality of received packets at a first node, each received packet being generated based on at least one base packet in a set of base packets,
determine a reduced set of base packet identifiers (IDs) for the plurality of received packets, the reduced set being a subset of an overall set comprising base packet IDs of all base packets for each of the plurality of received packets, and
send information conveying the reduced set of base packet IDs to at least one node; and
a memory coupled to the at least one processor.

16. The apparatus of claim 15, wherein the at least one processor is configured to:
receive a network-coded packet generated by a second node based on the information sent by the first node; and
recover a base packet intended for the first node based on the network-coded packet and at least one of the plurality of received packets.

17. The apparatus of claim 15, wherein the at least one processor is configured to:
determine at least one base packet ID of at least one base packet used to generate each of the plurality of received packets;
determine the overall set to include the at least one base packet ID of the at least one base packet used to generate each of the plurality of received packets; and
process the overall set to reduce a number of base packet IDs used to represent the plurality of received packets and obtain the reduced set of base packet IDs.

18. The apparatus of claim 15, wherein the at least one processor is configured to:
determine a coefficient matrix for the plurality of received packets;
process the coefficient matrix to reduce a number of non-zero elements in the coefficient matrix; and
determine the reduced set of base packet IDs based on non-zero elements of the processed coefficient matrix.

19. An apparatus for wireless communication, comprising:
means for obtaining a plurality of received packets at a first node, each received packet being generated based on at least one base packet in a set of base packets;
means for determining a reduced set of base packet identifiers (IDs) for the plurality of received packets, the reduced set being a subset of an overall set comprising base packet IDs of all base packets for each of the plurality of received packets; and
means for sending information conveying the reduced set of base packet IDs to at least one node.

20. The apparatus of claim 19, further comprising:
means for receiving a network-coded packet generated by a second node based on the information sent by the first node; and
means for recovering a base packet intended for the first node based on the network-coded packet and at least one of the plurality of received packets.

21. The apparatus of claim 19, further comprising:
means for determining at least one base packet ID of at least one base packet used to generate each of the plurality of received packets;
means for determining the overall set to include the at least one base packet ID of the at least one base packet used to generate each of the plurality of received packets; and
means for processing the overall set to reduce a number of base packet IDs used to represent the plurality of received packets and obtain the reduced set of base packet IDs.

22. The apparatus of claim 19, further comprising:
means for determining a coefficient matrix for the plurality of received packets;
means for processing the coefficient matrix to reduce a number of non-zero elements in the coefficient matrix; and
means for determining the reduced set of base packet IDs based on non-zero elements of the processed coefficient matrix.

23. A computer-readable storage medium, comprising:
code for causing at least one processor to obtain a plurality of received packets at a first node, each received packet being generated based on at least one base packet in a set of base packets;
code for causing the at least one processor to determine a reduced set of base packet identifiers (IDs) for the plurality of received packets, the reduced set being a subset of an overall set comprising base packet IDs of all base packets for each of the plurality of received packets; and
code for causing the at least one processor to send information conveying the reduced set of base packet IDs to at least one node.

24. A method for wireless communication, comprising:
sending first information identifying base packets used to generate at least one received packet at a first node, each received packet being generated based on at least one base packet in a set of base packets;
obtaining at least one additional received packet at the first node, each additional received packet being generated based on at least one base packet in the set of base packets;
determining second information identifying base packets used to generate the at least one additional received packet, the second information being determined based on the first information; and
sending the second information to at least one node.

25. The method of claim 24, further comprising:
receiving a network-coded packet generated by a second node based on the first and second information sent by the first node; and
recovering a base packet intended for the first node based on the network-coded packet.

26. The method of claim 24, further comprising:
forming a coefficient matrix based on the at least one received packet and the at least one additional received packet;
processing the coefficient matrix to reduce a number of non-zero elements in the coefficient matrix; and
determining a reduced set of base packets for the at least one additional received packet based on the processed coefficient matrix.

27. The method of claim 26, wherein the forming the coefficient matrix comprises
forming a first portion of the coefficient matrix based on the at least one received packet, and
forming a second portion of the coefficient matrix based on the at least one additional received packet.

28. The method of claim 27, wherein the processing the coefficient matrix comprises processing the second portion of the coefficient matrix to reduce a number of non-zero elements in the second portion while maintaining the first portion of the coefficient matrix.

29. The method of claim 27, wherein the processing the coefficient matrix comprises processing the second portion of the coefficient matrix based on Gaussian elimination or Gauss-Jordan elimination.

30. The method of claim 27, wherein the processing the coefficient matrix comprises processing the coefficient matrix to obtain a row echelon form (REF) or a reduced row echelon form (RREF) for the second portion of the coefficient matrix.

31. The method of claim 26, further comprising:
performing post-processing on the processed coefficient matrix to obtain a post-processed coefficient matrix having fewer non-zero elements than the processed coefficient matrix.

32. The method of claim 31, further comprising:
obtaining at least one new received packet at the first node;
determining base packets used to generate the at least one new received packet; and
determining a reduced set of base packets for the at least one new received packet based on the post-processed coefficient matrix and the base packets used to generate the at least one new received packet.

33. The method of claim 31, further comprising:
receiving a network-coded packet generated by a second node based on the post-processed coefficient matrix.

34. An apparatus for wireless communication, comprising:
at least one processor configured to:
send first information identifying base packets used to generate at least one received packet at a first node, each received packet being generated based on at least one base packet in a set of base packets,
obtain at least one additional received packet at the first node, each additional received packet being generated based on at least one base packet in the set of base packets,
determine second information identifying base packets used to generate the at least one additional received packet, the second information being determined based on the first information, and
send the second information to at least one node; and
a memory coupled to the at least one processor.

35. The apparatus of claim 34, wherein the at least one processor is configured to:
form a coefficient matrix based on the at least one received packet and the at least one additional received packet;
process the coefficient matrix to reduce a number of non-zero elements in the coefficient matrix; and
determine a reduced set of base packets for the at least one additional received packet based on the processed coefficient matrix.

36. The apparatus of claim 35, wherein the at least one processor is configured to:
forming a first portion of the coefficient matrix based on the at least one received packet, and
forming a second portion of the coefficient matrix based on the at least one additional received packet.

37. The apparatus of claim 35, wherein the at least one processor is configured to perform post-processing on the processed coefficient matrix to obtain a post-processed coefficient matrix having fewer non-zero elements than the processed coefficient matrix.

38. An apparatus for wireless communication, comprising:
means for sending first information identifying base packets used to generate at least one received packet at a first node, each received packet being generated based on at least one base packet in a set of base packets;
means for obtaining at least one additional received packet at the first node, each additional received packet being generated based on at least one base packet in the set of base packets;
means for determining second information identifying base packets used to generate the at least one additional received packet, the second information being determined based on the first information; and
means for sending the second information to at least one node.

39. The apparatus of claim 38, further comprising:
means for forming a coefficient matrix based on the at least one received packet and the at least one additional received packet;
means for processing the coefficient matrix to reduce a number of non-zero elements in the coefficient matrix; and
means for determining a reduced set of base packets for the at least one additional received packet based on the processed coefficient matrix.

40. The apparatus of claim 39, wherein the means for forming the coefficient matrix comprises
means for forming a first portion of the coefficient matrix based on the at least one received packet, and
means for forming a second portion of the coefficient matrix based on the at least one additional received packet.

41. The apparatus of claim 39, further comprising:
means for performing post-processing on the processed coefficient matrix to obtain a post-processed coefficient matrix having fewer non-zero elements than the processed coefficient matrix.

42. A computer-readable storage medium, comprising:
code for causing at least one processor to send first information identifying base packets used to generate at least one received packet at a first node, each received packet being generated based on at least one base packet in a set of base packets;
code for causing the at least one processor to obtain at least one additional received packet at the first node, each additional received packet being generated based on at least one base packet in the set of base packets;
code for causing the at least one processor to determine second information identifying base packets used to generate the at least one additional received packet, the second information being determined based on the first information; and
code for causing the at least one processor to send the second information to at least one node.

43. A method for wireless communication, comprising:
receiving first information from a first node at a second node, the first information conveying a reduced set of base packet identifiers (IDs) for a plurality of received packets at the first node, the reduced set being a subset of an overall set comprising base packet IDs of all base packets for each of the plurality of received packets at the first node;
receiving additional information from at least one other node at the second node, the additional information conveying base packet IDs for received packets at the at least one other node;
generating a network-coded packet based on the first information from the first node and the additional information from the at least one other node; and
sending the network-coded packet to the first node and the at least one other node.

44. The method of claim 43, further comprising:
performing a decodability check for the first node to determine whether the network-coded packet can be used by the first node to recover a base packet intended for the first node.

45. The method of claim 43, further comprising:
receiving second information from the first node at the second node, the second information conveying a second set of base packet IDs for at least one additional received packet at the first node; and
generating a second network-coded packet based on the first and second information from the first node.

46. The method of claim 45, further comprising:
forming a first portion of a coefficient matrix for the first node based on the reduced set of base packet IDs;
forming a second portion of the coefficient matrix for the first node based on the second set of base packet IDs; and
performing post-processing on the coefficient matrix to obtain a post-processed coefficient matrix having fewer non-zero elements than the coefficient matrix.

47. The method of claim 46, further comprising:
generating a second network-coded packet based on the post-processed coefficient matrix.

48. An apparatus for wireless communication, comprising:
at least one processor configured to:
receive first information from a first node at a second node, the first information conveying a reduced set of base packet identifiers (IDs) for a plurality of received packets at the first node, the reduced set being a subset of an overall set comprising base packet IDs of all base packets for each of the plurality of received packets at the first node;
receive additional information from at least one other node at the second node, the additional information conveying base packet IDs for received packets at the at least one other node;
generate a network-coded packet based on the first information from the first node and the additional information from the at least one other node; and
send the network-coded packet to the first node and the at least one other node.

49. The apparatus of claim 48, wherein the at least one processor is configured to:
receive second information from the first node at the second node, the second information conveying a second set of base packet IDs for at least one additional received packet at the first node; and
generate a second network-coded packet based on the first and second information from the first node.

50. The apparatus of claim 49, wherein the at least one processor is configured to:
form a first portion of a coefficient matrix for the first node based on the reduced set of base packet IDs;
form a second portion of the coefficient matrix for the first node based on the second set of base packet IDs; and
perform post-processing on the coefficient matrix to obtain a post-processed coefficient matrix having fewer non-zero elements than the coefficient matrix.

51. An apparatus for wireless communication, comprising:
means for receiving first information from a first node at a second node, the first information conveying a reduced set of base packet identifiers (IDs) for a plurality of received packets at the first node, the reduced set being a subset of an overall set comprising base packet IDs of all base packets for each of the plurality of received packets at the first node;
means for receiving additional information from at least one other node at the second node, the additional information conveying base packet IDs for received packets at the at least one other node;
means for generating a network-coded packet based on the first information from the first node and the additional information from the at least one other node; and
means for sending the network-coded packet to the first node and the at least one other node.

52. The apparatus of claim 51, further comprising:
means for receiving second information from the first node at the second node, the second information conveying a second set of base packet IDs for at least one additional received packet at the first node; and
means for generating a second network-coded packet based on the first and second information from the first node.

53. The apparatus of claim 52, further comprising:
means for forming a first portion of a coefficient matrix for the first node based on the reduced set of base packet IDs;
means for forming a second portion of the coefficient matrix for the first node based on the second set of base packet IDs; and
means for performing post-processing on the coefficient matrix to obtain a post-processed coefficient matrix having fewer non-zero elements than the coefficient matrix.

54. A computer-readable storage medium, comprising:
code for causing at least one processor to receive first information from a first node at a second node, the first information conveying a reduced set of base packet identifiers (IDs) for a plurality of received packets at the first node, the reduced set being a subset of an overall set comprising base packet IDs of all base packets for each of the plurality of received packets at the first node;
code for causing the at least one processor to receive additional information from at least one other node at the second node, the additional information conveying base packet IDs for received packets at the at least one other node;
code for causing the at least one processor to generate a network-coded packet based on the first information from the first node and the additional information from the at least one other node; and
code for causing the at least one processor to send the network-coded packet to the first node and the at least one other node.
